(19) United States
(12) Patent Application Publication
(10) Pub. No.: US 2023/0345395 A1
(43) Pub. Date: Oct. 26, 2023

(54) MEASUREMENT OPPORTUNITY SHARING FOR LAYER ONE MEASUREMENTS

(71) Applicant: Apple Inc., Cupertino, CA (US)

(72) Inventors: Yang Tang, San Jose, CA (US); Dawei Zhang, Saratoga, CA (US); Jie Cui, San Jose, CA (US); Manasa Raghavan, Sunnyvale, CA (US); Qiming Li, Beijing (CN); Xiang Chen, Campbell, CA (US)

(73) Assignee: Apple Inc., Cupertino, CA (US)

(21) Appl. No.: 18/136,251

(22) Filed: Apr. 18, 2023

Related U.S. Application Data
(60) Provisional application No. 63/334,561, filed on Apr. 25, 2022.

(51) Int. Cl. H04W 56/00; H04W 24/10; H04W 76/19; H04W 76/28

(52) U.S. Cl. CPC H04W 56/0015; H04W 24/10; H04W 76/19; H04W 76/28

(57) ABSTRACT

The present application relates to devices and components including apparatus, systems, and methods for sharing Layer 1 measurement opportunities in wireless networks.

### CROSS-REFERENCE TO RELATED APPLICATION

This application claims priority to U.S. Provisional Patent Application No. 63/334,561, filed Apr. 25, 2022, which is hereby incorporated by reference in its entirety.

### FIELD

This application relates to the field of wireless networks and, in particular, to measurement opportunity sharing for layer one measurements in said networks.

### BACKGROUND

Third Generation Partnership Project (3GPP) defines a number of reference signals to facilitate communications in a wireless access cell. A base station may configure a user equipment (UE) to perform and report measurements on these reference signals in order to perform various beam and link management operations.

### BRIEF DESCRIPTION OF THE DRAWINGS

FIG. 1 illustrates a network environment, in accordance with some embodiments.

FIG. 2 illustrates configured measurement opportunities in accordance with some embodiments.

FIG. 3 illustrates further configured measurement opportunities in accordance with some embodiments.

FIG. 4 illustrates further configured measurement opportunities in accordance with some embodiments.

FIG. 5 illustrates further configured measurement opportunities in accordance with some embodiments.

FIG. 6 illustrates an operational flow/algorithmic structure in accordance with some embodiments.

FIG. 7 illustrates another operational flow/algorithmic structure, in accordance with some embodiments.

FIG. 8 illustrates another operational flow/algorithmic structure, in accordance with some embodiments.

FIG. 9 illustrates an user equipment in accordance with some embodiments.

FIG. 10 illustrates a network node in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, and/or techniques in order to provide a thorough understanding of the various aspects of some embodiments. However, it will be apparent to those skilled in the art having the benefit of the present disclosure that the various aspects of the various aspects may be practiced in other examples that depart from these specific details. In certain instances, descriptions of well-known devices, circuits, and methods are omitted so as not to obscure the description of the various aspects with unnecessary detail. For the purposes of the present document, the phrase “A or B” means (A), (B), or (A and B).

The following is a glossary of terms that may be used in this disclosure.

The term “circuitry” as used herein refers to, is part of, or includes hardware components, such as an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), and/or digital signal processors (DSPs), that are configured to provide the described functionality. In some aspects, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these aspects, the combination of hardware elements and program code may be referred to as a particular type of circuitry.

The term “processor circuitry” as used herein refers to, is part of, or includes circuitry capable of sequentially and automatically carrying out a sequence of arithmetic or logical operations; or recording, storing, or transferring digital data. The term “processor circuitry” may refer an application processor; baseband processor; a central processing unit (CPU); a graphics processing unit; a single-core processor; a dual-core processor; a triple-core processor; a quad-core processor; or any other device capable of executing or otherwise operating computer-executable instructions, such as program code; software modules; or functional processes.

The term “interface circuitry” as used herein refers to, is part of, or includes circuitry that enables the exchange of information between two or more components or devices. The term “interface circuitry” may refer to one or more hardware interfaces; for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “computer system” as used herein refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to computer, storage, or network resources provided by physical hardware element(s). A “virtualized resource” may refer to computer, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element or a data element that contains content. An information element may include one or more additional information elements.

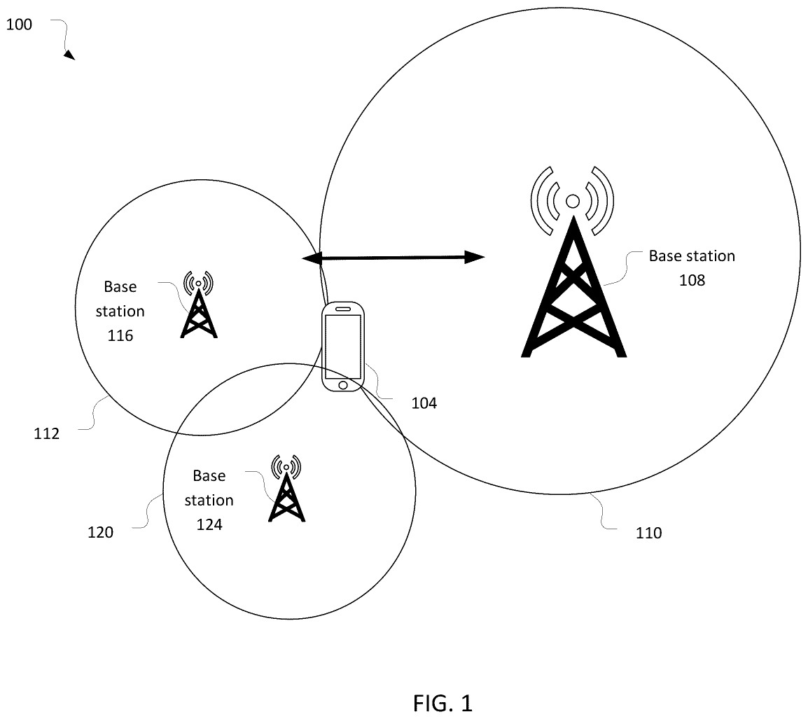

FIG. 1 illustrates a network environment 100 in accordance with some embodiments. The network environment 100 may include a UE 104 and a base station 108. The base station 108 may provide a serving cell 110 through which the UE 104 may communicate with the base station 108. In some embodiments, the base station 108 is a next-generation node B (gNB) that provides one or more 3GPP New Radio (NR) cells. In other embodiments, the base station 108 is an evolved node B (eNB) that provides one or more Long Term Evolution (LTE) cells. The air interface over which the UE 104 and base station 108 communicate may be compatible with 3GPP technical specifications, such as those that define Fifth Generation (5G) NR system standards.

The network environment 100 may further include one or more neighbor base stations, for example, base stations 116 and 124 that provide non-serving cells 112 and 120, respectively. The base stations 116 and 124 may use the same radio access technology as the base station 108 or a different radio access technology.

To adapt to changes in a radio environment and relative positioning between the UE 104 and the base stations, the UE 104 may be configured to perform a variety of measurements on reference signals transmitted in both the serving cell 110 and the non-serving cells 112 and 120. The base station 108 may transmit a measurement configuration to provide the UE 104 with information to perform the reference signal measurements. Upon performing the measurements, the UE 104 may provide a measurement report to the base station 108. The base station 108 may perform various radio resource management (RRM) operations based on the measurement report.

The measurement configuration may instruct the UE 104 to perform intra-frequency measurements based on reference signals that include, for example, synchronization signal and physical broadcast channel block (SSB) resources. The measurements may be beam-level or cell-level. SSB intra-frequency measurements may correspond to situations in which the serving cell 110, non-serving cell 112, and non-serving cell 120 use the same SSB center frequency and subcarrier spacing.

The measurement configuration may be transmitted to the UE 104 while the UE 104 is in a radio resource control (RRC)-connected mode by dedicated signaling, such as RRC signaling (for example, an RRC reconfiguration message or RRC resume message).

In some embodiments, a measurement configuration may include (directly or by reference) a measurement identity, a measurement object, and a reporting configuration. The measurement identity may link a reporting configuration to a measurement object. The measurement identity may include a first pointer toward a reporting configuration and a second pointer toward a measurement object that provides information about the SSB resources that are to be measured. The UE 104 may provide measurement results within an RRC message (for example, an RRC measurement report) that includes the measurement ID as a reference.

The reporting configuration may provide a periodic, event-triggered, or cell global identity (CGI) configuration. The reporting configuration may include parameters, such as report amount, reporting interval, and, if the configuration is an event-triggered configuration, a measurement reporting event. The report amount and reporting interval may be abstract syntax notation one (ASN.1) fields in a report configuration information element (IE). The report amount may describe how many times a measurement report is to be transmitted based on a triggering event. The triggering event may be a period elapsing (for a periodic configuration) or a triggering condition of a measurement reporting event being satisfied (for an event-triggered configuration). The reporting interval may provide a time between successive transmissions of the measurement report. The reporting configuration may further describe the reference signal type (for example, SSB) that may be used for the periodic or event-triggered configurations.

The SSBs may be used for reference signal receive power (RSRP) measurements at Layer 1 (L1) or Layer 3 (L3). The L1 measurements may be used to monitor and respond to radio channel conditions on a shorter time frame as compared with L3 measurements. The L1 measurements may be used to, for example, perform beam management procedures, while the L3 measurements may be used to, for example, perform handover procedures.

Typically, the UE 104 may only perform L1 measurements for beam management on the serving cell 110. However, in some instances, for example, when the base stations 116 and 124 correspond to multi-transmit-receive points (multi-TRPs), the UE 104 may perform L1 measurements for beam management on both the serving cell 110 and the non-serving cells 112 and 120. When the UE 104 measures different cells, it may need to use different beams. This may be especially true when the UE 104 is operating in the higher frequency ranges, for example, frequency range 2 (FR2), from 24.25 GHz to 52.6 GHz, or above. Thus, when measurement opportunities for serving cell (SC) and non-serving cell (NSC) SSBs collide, the UE 104 may need to choose which cell is to be measured. Various embodiments describe how measurement opportunities are to be shared among L1 and L3 measurements.

The measurement configurations may define periodicity, offset, and duration of measurement opportunities that may be used for SSB-based L1/L3 measurements. An SSB measurement timing configuration (SMTC) may define the measurement opportunities for performing the L3 measurements.

Measurement opportunities for performing L1-RSRP measurements on a serving cell may be at least partially defined by T_SSB,SC, which represents a periodicity of the SSB index configured for L1 RSRP measurement of the SC. Measurement opportunities for performing L1-RSRP measurements on an NSC may be at least partially defined by T_SSB,NSC, which represents a periodicity of the SSB index configured for L1 RSRP measurement of the NSCs. And measurement opportunities for performing L3-RSRP measurements on a serving cell may be at least partially defined by T_SSB,SC, which represents a periodicity of the SSB index configured for L3 RSRP measurement.

In some embodiments, the L1 measurement opportunities (and potentially the L3 measurement opportunities as well) may be configured in an aligning manner such that at least some instances of one type of measurement opportunity overlap with at least some instances of the other types of measurement opportunities. This may be accomplished by configuring the measurement opportunities with a common offset and duration (for example, SSB burst set length) and aligned periodicities (for example, one periodicity is equal to or a multiple of another periodicity). One SSB or one SSB burst set (if the SSB burst set length is greater than one) may be transmitted by the SC/NSC in one measurement opportunity.

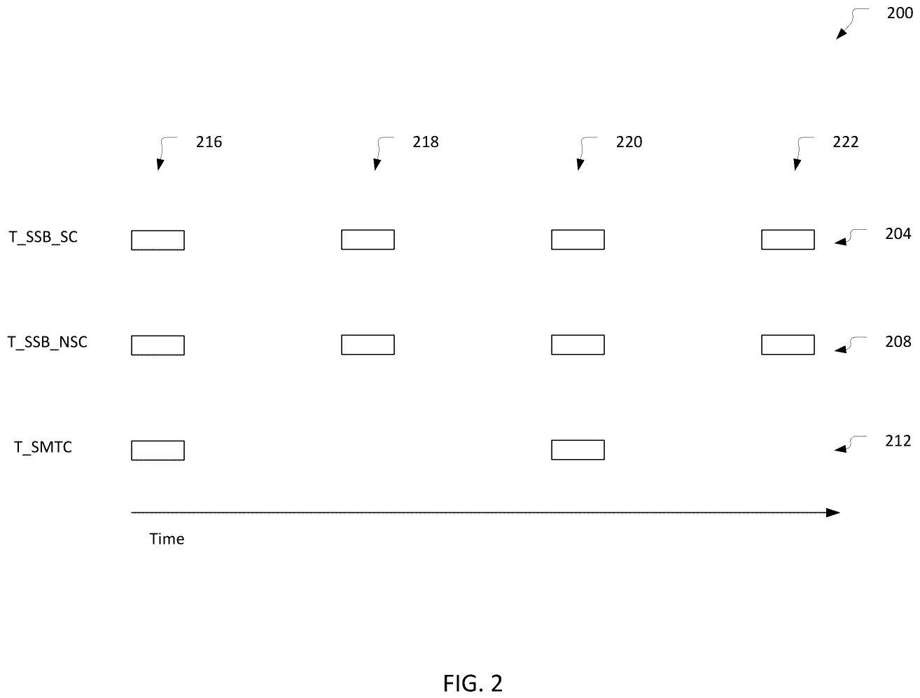

FIG. 2 illustrates various measurement opportunities 200 in accordance with some embodiments. The measurement opportunities 200 may include L1 SC measurement opportunities 204 for performing L1-RSRP measurements on a serving cell. The L1 SC measurement opportunities 204 may have a periodicity equal to T_SSB,SC. The measurement opportunities 200 may further include L1 NSC measurement opportunities 208 for performing L1-RSRP measurements on an NSC. The L1 NSC measurement opportunities 208 may have a periodicity equal to T_SSB,NSC. The measurement opportunities 200 may further include L3 measurement opportunities 212 for performing L3-RSRP measurements. The L3 measurement opportunities 212 may have a periodicity equal to T_SMTC. As shown, T_SSB, SC=T_SSB,NSC<T_SMTC.

At instances 216 and 220 (which may be subframes, for example), L1 SC measurement opportunities collide with both L1 NSC measurement opportunities and L3 measurement opportunities; and at instances 218 and 222, L1 SC measurement opportunities may collide with L1 NSC measurement opportunities. At each instance, the UE 104 may need to determine which measurements to perform in which of the overlapped measurement opportunities.

Clause 9.5.4 of 3GPP TS 38.133 v17.5.0 (2022 March) defines a sharing factor, P, that informs the UE 104 of how to share L1-RSRP measurement opportunities with measurement gap and L3-RSPR measurement opportunities. As P is directed, at least partially, to sharing between L1 and L3 measurement opportunities, it may be referred to herein as an inter-layer sharing factor, where L1 and L3 measurements are considered as different layers. Embodiments of the present disclosure provide an additional sharing factor, P_L1, that may inform the UE 104 of how to share between L1 measurement opportunities that belong to serving cell and non-serving cells. As P_L1 is directed to sharing between L1 measurement opportunities, it may be referred to herein as an intra-layer sharing factor.

The intra-layer sharing factor may be based on a number of factors including whether the SC measurements are prioritized over the NSC measurements and the number of NSCs configured for measurements. In general, the intra-layer sharing factor may indicate how many available measurement opportunities are needed to perform one L1 measurement. For example, if the intra-layer sharing factor is one, the UE 104 may perform one L1 measurement in every available measurement opportunity, if the intra-layer sharing factor is two, the UE 104 may perform one L1 measurement in every two available measurement opportunities, and so on. Measurement opportunities available for L1 measurements, as used herein, may refer to the L1 measurement opportunities outside of SMTC.

In embodiments in which T_SSB,SC is equal to T_SSB,NSC and they are both less than T_SMTC (as shown in FIG. 2), the intra-layer sharing factor, P_L1, for SC may be defined as follows:

P_L1=1+k*N_NSC, Equation 1

where k is a weighting factor and N_NSC is a number of NSCs configured for measurements.

The weighting factor, k, may be set with a value that is associated with a relative priority given between the SC measurements and the NSC measurements. For example, if the SC measurements are prioritized over the NSC measurements, k may be less than one; if the NSC measurements are prioritized over the SC measurements, k may be greater than one; and if the SC measurements and the NSC measurements have equal priorities (for example, the measurements opportunities are to be shared equally), k may be equal to one. In various embodiments, k may be predefined by a 3GPP TS, determined by the network and provided to the UE 104, or determined by the UE 104 and provided to network.

The UE 104 may use the P_L1 for SC to select a subset of the total number of available L1 SC measurement opportunities 204 that may be used for performing L1-RSRP measurements on SSBs transmitted by the SC.

In embodiments in which T_SSB,SC is equal to T_SSB,NSC and they are both less than T_SMTC (as shown in FIG. 2), the intra-layer sharing factor, P_L1, for NSC may be defined as follows:

P_L1=(1+k*NNSC)/k, Equation 2

where k and N_NSC are defined similar to that described above with respect to Equation 1. The UE 104 may use the P_L1 for NSC to select a subset of the total number of available L1 NSC measurement opportunities 208 that may be used for performing L1-RSRP measurements on SSBs transmitted by the NSCs.

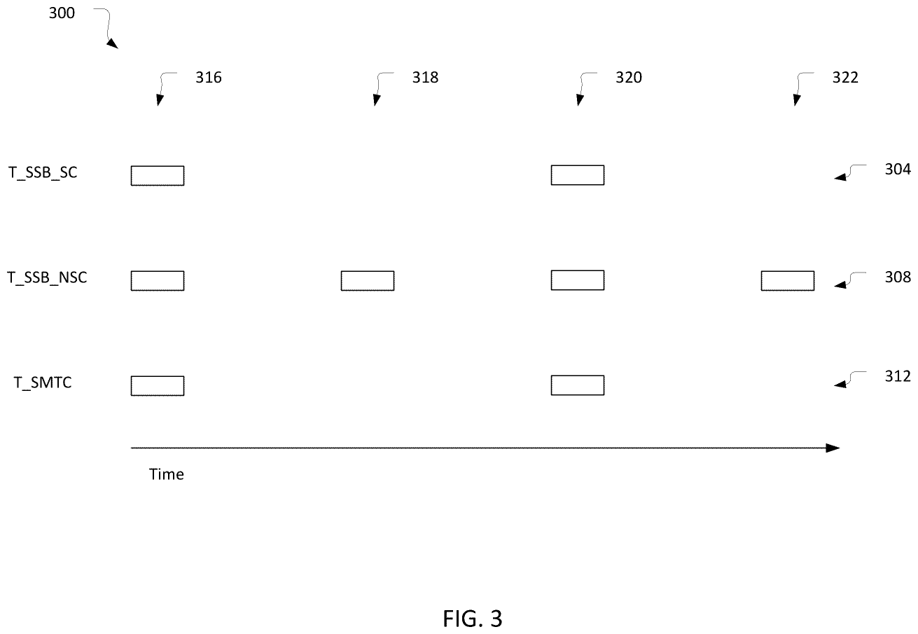

FIG. 3 illustrates various measurement opportunities 300 in accordance with some embodiments. The measurement opportunities 300 may include L1 SC measurement opportunities 304 for performing L1-RSRP measurements on a serving cell. The L1 SC measurement opportunities 304 may have a periodicity equal to T_SSB,SC. The measurement opportunities 300 may further include L1 NSC measurement opportunities 308 for performing L1-RSRP measurements on an NSC. The L1 NSC measurement opportunities 308 may have a periodicity equal to T_SSB,NSC. The measurement opportunities 300 may further include L3 measurement opportunities 312 for performing L3-RSRP measurements. The L3 measurement opportunities 312 may have a periodicity equal to T_SMTC. As shown, T_SSB,NSC<T_SSB, SC=T_SMTC.

At instances 316 and 320 (which may be subframes, for example), L1 SC measurement opportunities collide with both L1 NSC measurement opportunities and L3 measurement opportunities; and at instances 318 and 322, L1 NSC measurement opportunities may not collide with any other measurement opportunities. At each instance, the UE 104 may need to determine which measurements to perform in which of the overlapped measurement opportunities.

In these embodiments, the intra-layer sharing factor, P_L1, for SC may be set equal to one. Thus, the UE 104 may use all available L1 SC measurement opportunities (for example, all L1 SC measurement opportunities outside of SMTC) for performing L1-RSRP measurements on SSBs transmitted by the SC. This may be desired given that the measurement opportunities of L1 SC are less dense than ones for NSCs.

The P_L1 for NSC may be set equal to N_NSC. For example, if only one NSC is configured for measurements, P_L1 for NSC may be equal to one and the UE 104 may use all available L1 NSC measurement opportunities (for example, the L1 NSC measurement opportunities outside of SMTC) for performing L1-RSRP measurements on SSBs transmitted by the NSC. If two NSCs are configured for measurements, P_L1 for NSC may be equal to two and the UE 104 may use one out of every two L1 NSC measurement opportunities for performing L1-RSRP measurements on SSBs transmitted by the NSC.

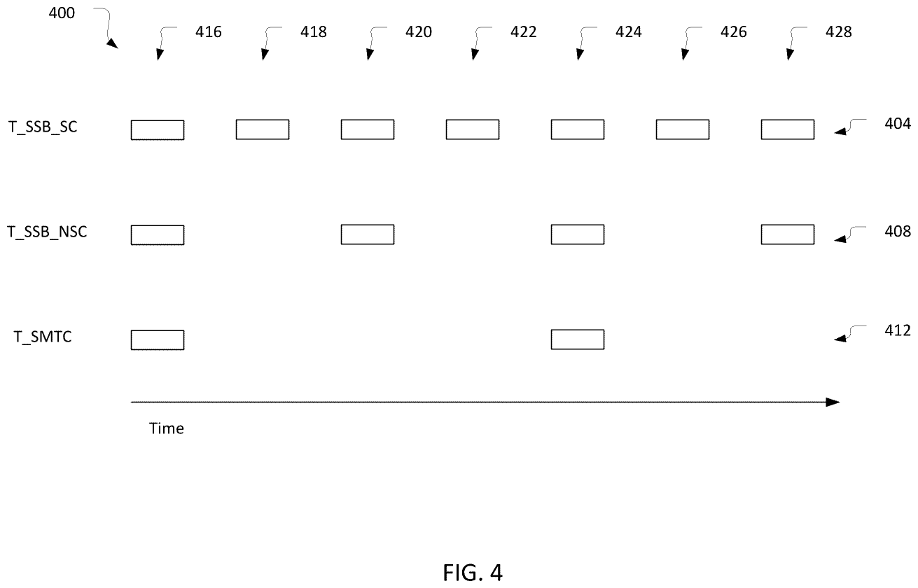

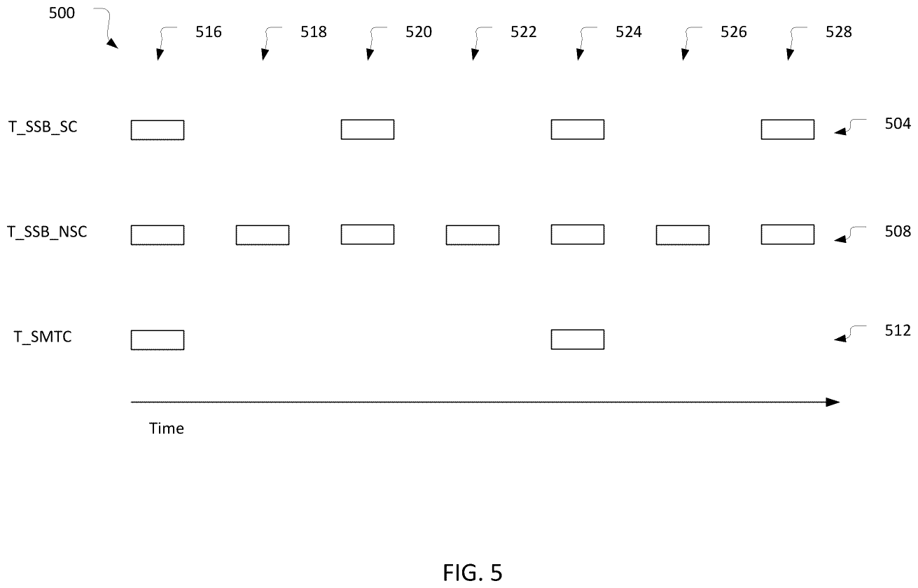

FIGS. 4 and 5 illustrate measurement opportunities in which all periodicities are different from one another. In these embodiments, one NSC may be configured for measurement (for example, N_NSC=1) and the intra-layer sharing factor may be determined as follows.

FIG. 4 illustrates various measurement opportunities 400 in accordance with some embodiments. The measurement opportunities 400 may include L1 SC measurement opportunities 404 for performing L1-RSRP measurements on a serving cell. The L1 SC measurement opportunities 404 may have a periodicity equal to T_SSB,SC. The measurement opportunities 400 may further include L1 NSC measurement opportunities 408 408 may have a periodicity equal to T_SSB,NSC. The measurement opportunities 400 may further include L3 measurement opportunities 412 for performing L3-RSRP measurements. The L3 measurement opportunities 412 may have a periodicity equal to T_SMTC. As shown, T_SSB, SC<T_SSB,NSC<T_SMTC.

At instances 416 and 424 (which may be subframes, for example), L1 SC measurement opportunities collide with both L1 NSC measurement opportunities and L3 measurement opportunities. At instances 420 and 428, L1 SC measurement opportunities may collide with L3 measurement opportunities. And, at instances 418, 422, and 426, the L1 SC measurement opportunities may not collide with either the L1 NSC measurement opportunities or the L3 measurement opportunities. At each instance, the UE 104 may need to determine which measurements to perform in which of the overlapped measurement opportunities.

In these embodiments, the intra-layer sharing factor, P_L1, for SC may be defined as (1−T_SSB,SC/T_SMTC))/(1−(T_SSB,SC/T_SSB,NSC)).

In these embodiments, the intra-layer sharing factor, P_L1, for NSC may be set equal to one. Thus, the UE 104 may use all available L1 NSC measurement opportunities (for example, the L1 SC measurement opportunities outside of SMTC) for performing L1-RSRP measurements on SSBs transmitted by the NSC. This may be desired given that the measurement opportunities for L1 SCs are less dense than those for the NSC.

Based on these definitions of the intra-layer sharing factor, when SC and NSC's SSB burst sets are partially overlapped, the cell with less SSB burst set periodicity will only be measured on occasions where the SC and NSC's SSB burst sets do not collide. For example, with reference to FIG. 4, as TS_SSB,SC is shorter than T_SSB,NSC, the L1 SC measurement opportunities may only be used to measure SSB(s) transmitted by the SC when they do not overlap with the L1 NSC SC measurement opportunities (for example, instances 418, 422, and 426).

FIG. 5 illustrates various measurement opportunities 500 in accordance with some embodiments. The measurement opportunities 500 may include L1 SC measurement opportunities 504 for performing L1-RSRP measurements on a serving cell. The L1 SC measurement opportunities 504 may have a periodicity equal to T_SSB,SC. The measurement opportunities 500 may further include L1 NSC measurement opportunities 508 508 may have a periodicity equal to T_SSB,NSC. The measurement opportunities 500 may further include L3 measurement opportunities 512 for performing L3-RSRP measurements. The L3 measurement opportunities 512 may have a periodicity equal to T_SMTC. As shown, T_SSB,NSC<T_SSB, SC<T_SMTC.

At instances 516 and 524 (which may be subframes, for example), L1 SC measurement opportunities collide with both L1 NSC measurement opportunities and L3 measurement opportunities. At instances 520 and 528, L1 SC measurement opportunities may collide with L3 measurement opportunities. And, at instances 518, 522, and 526, the L1 NSC measurement opportunities may not collide with either the L1 NSC measurement opportunities or the L3 measurement opportunities. At each instance, the UE 104 may need to determine which measurements to perform in which of the overlapped measurement opportunities.

In these embodiments, the intra-layer sharing factor, P_L1, for NSC may be defined as (1−T_SSB,NSC/T_SMTC))/(1−(T_SSB,NSC/T_SSB,SC)).

In these embodiments, the intra-layer sharing factor, P_L1, for SC may be set equal to one. Thus, the UE 104 may use all available L1 SC measurement opportunities (for example, measurement opportunities outside of SMTC) for performing L1-RSRP measurements on SSBs transmitted by the SC. This may be desired given that the L1 SC measurement opportunities are less dense than the other measurement opportunities.

Similar to that described above with respect to FIG. 4, based on these definitions of the intra-layer sharing factor, when SC and NSC's SSB burst sets are partially overlapped, the cell with less SSB burst set periodicity will only be measured on occasions where the SC and NSC's SSB burst sets do not collide. For example, with reference to FIG. 5, as TS SSB,NSC is shorter than T_SSB,SC, the L1 NSC measurement opportunities may only be used to measure SSB(s) transmitted by the NSC when they do not overlap with the L1 SC measurement opportunities (for example, instances 518, 522, and 526).

To comply with clause 9.5.4 of 3GPP TS 38.133, a physical layer of the UE 104 may need to be capable of reporting L1-RSRP measurements over an L1 measurement period, T_L1-RSRP_Measurement_Period_SSB. If the UE 104 does not report configured L1-RSRP measurements over the L1 measurement period, the base station 108 may determine there is a beam or radio-link failure and attempt to perform a radio resource management (RRM) operation such as configuring a new beam or cell.

3GPP TS 38.133 currently bases the L1 measurement period on the inter-layer sharing factor. Embodiments of the present disclosure describe using the intra-layer sharing factor as an additional basis for determining the L1 measurement period as follows.

In FR2, when intra-frequency L1 measurements for NSC is considered, the L1 measurement period may be determined as follows. Unless described elsewhere herein, the parameters used to calculate the L1 measurement period may be similar to like-named parameters in clause 9.5.4.1 of 3GPP TS 38.133.

If the UE 104 is not operating in accordance with a discontinuous reception (DRX) configuration, the L1 measurement period may be equal to max(T_report, cell (M*P*N*P_L1)*T_SSB). T_report may be a configured periodicity for reporting, T_SSB may be the periodicity of an SSB index configured for L1-RSRP measurements of the SC or the NSC, T_DRX is a DRX cycle length, M is equal to one if a time restriction for channel measurement parameter is configured or is equal to three otherwise, P is the inter-layer sharing factor, and N is eight.

If the UE 104 is operating in accordance with a DRX configuration not more than 320 milliseconds, the L1 measurement period may be equal to max(T_report, cell (1.5*M*P*N*P_L1)*max (T_DRX, T_SSB). The parameters may be similar to the described above and, with the exception of P_L1, described in clause 9.5.4.1 of TS 38.133.

If the UE 104 is operating in accordance with a DRX configuration more than 320 milliseconds, the L1 measurement period may be equal to ceil(1.5*M*P*N*P_L1)*T_DRX. The parameters may be similar to that described above and, with the exception of P_L1, described in clause 9.5.4.1 of TS 38.133.

In some embodiments, the L1 measurement period may be determined with respect to high-speed environments by making similar changes (for example, incorporation of P_L1) to Table 9.5.4.1-3 of TS 38.133.

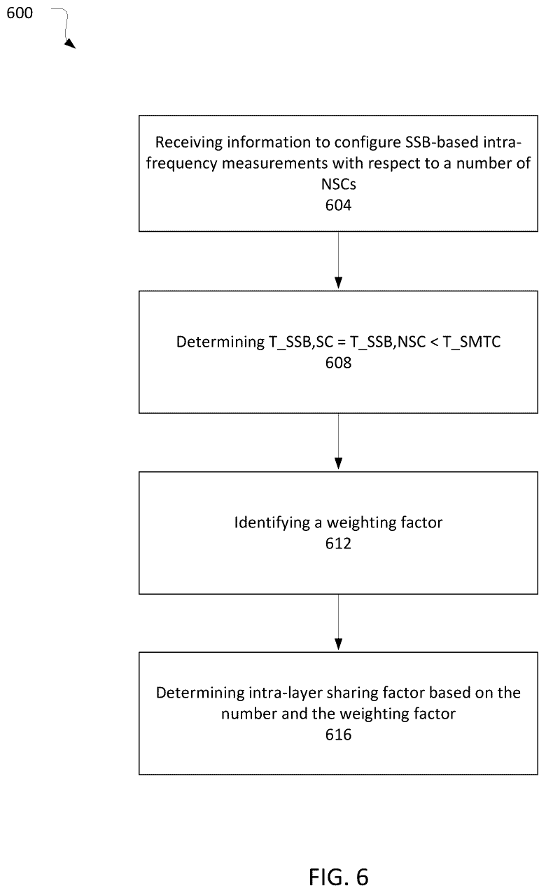

FIG. 6 illustrates an operation flow/algorithmic structure 600 in accordance with some aspects. The operation flow/algorithmic structure 600 may be performed or implemented by a UE, such as UE 104 or 900; or components thereof; for example, baseband processor circuitry 904A.

The operation flow/algorithmic structure 600 may include, at 604, receiving information to configure SSB-based intra-frequency measurements with respect to a number of NSCs. The measurements may be L1-RSRP measurements configured for one or more NSCs. In some embodiments, the information may be received in one or more configuration messages and may also configure other L1 measurements, e.g., L1-RSRP measurements of SSBs of the SC, and L3 measurements. The information may provide various periodicity information such as, for example, T_SSB,SC, T_SSB,NSC, and T_SMTC.

The operation flow/algorithmic structure 600 may further include, at 608, determining T_SSB,SC=T_SSB,NSC<T_SMTC. Thus, the L1 measurement opportunities may be configured with the same periodicity, and that periodicity may be less than the periodicity of the L3 measurement opportunities.

The operation flow/algorithmic structure 600 may further include, at 612, identifying a weighting factor. As described above, the weighting factor, k, may be set with a value that is associated with a relative priority given between the SC measurements and the NSC measurements. For example, if the SC measurements are prioritized over the NSC measurements, k may be less than one; if the SC measurements are de-prioritized (for example, NSC measurements are prioritized over the SC measurements), k may be greater than one; and if the SC measurements and the NSC measurements have equal priorities (for example, the measurements opportunities are to be shared equally), k may be equal to one. In various embodiments, k may be predefined by a 3GPP TS, determined by the network and provided to the UE in the configuration information, or determined by the UE 104.

The operation flow/algorithmic structure 600 may further include, at 616, determining an intra-layer sharing factor. This determination may be based on the number of NSCs configured for measurement and the weighting factor.

The intra-layer sharing factor for SC may be for set is equal to 1+k*N_NSC. The UE may then use the intra-layer sharing factor for SC to select a subset of a plurality of available L1 SC measurement opportunities and perform the L1 measurements of the SC within the subset.

The UE may also determine an intra-layer sharing factor for NSC as equal to (1+k*N_NSC)/k. The UE may then use the intra-layer sharing factor for NSC to select a subset of a plurality of available L1 NSC measurement opportunities and perform the L1 measurements of the NSC within the subset. The plurality of L1 SC measurements may correspond to the L1 NSC measurement opportunities in this embodiment.

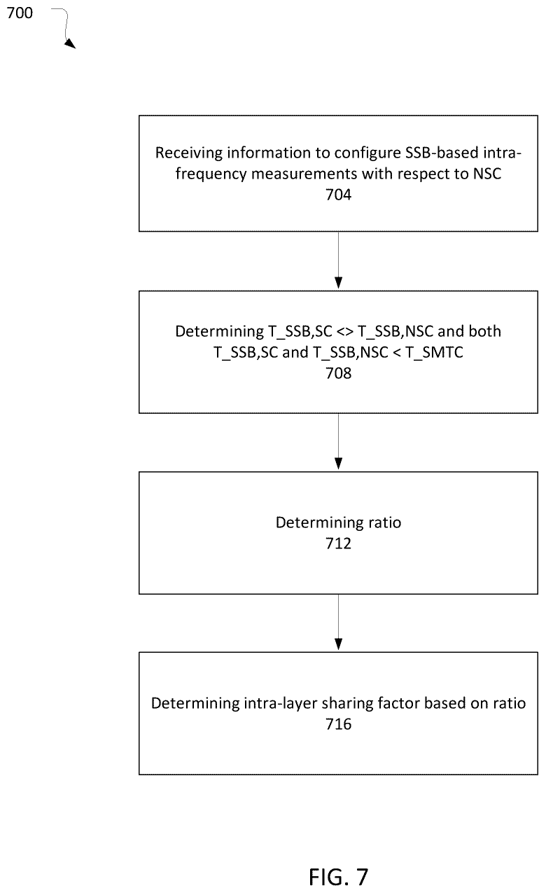

FIG. 7 illustrates an operation flow/algorithmic structure 700 in accordance with some aspects. The operation flow/algorithmic structure 700 may be performed or implemented by a UE, such as UE 104 or 900; or components thereof; for example, baseband processor circuitry 904A.

The operation flow/algorithmic structure 700 may include, at 704, receiving information to configure SSB-based intra-frequency measurements with respect to a number of NSCs. The received information may be similar to that described elsewhere herein including, for example, the operation flow/algorithmic structure 600 of FIG. 6.

The operation flow/algorithmic structure 700 may further include, at 708, determining T_SSB,SC is not equal to T_SSB,NSC and both T_SSB,SC and T_SSB,NSC are less than T_SMTC. Thus, the L1 measurement opportunities may be configured with different periodicities, both of which may be less than the periodicity of the L3 measurement opportunities.

The operation flow/algorithmic structure 700 may further include, at 712, determining a ratio. The ratio may be a ratio of one of the L1 measurement periodicities to the L3 measurement periodicity.

The operation flow/algorithmic structure 700 may further include, at 716, determining an intra-layer sharing factor based on the ratio determined at 712.

In the event T_SSB,SC is less than T_SSB,NSC, the ratio may be the T_SSB,SC to the T_SMTC. In this embodiment, the intra-layer scaling factor for SC may be defined as (1−(T_SSB,SC/T_SMTC))/(1−(T_SSB,SC/T_SSB,NSC)). The UE may then use the intra-layer sharing factor for SC to select a subset of a plurality of available L1 SC measurement opportunities and perform the L1 measurements of the SC within the subset.

The intra-layer sharing factor for NSC may be set equal to one. The UE may then use the intra-layer sharing factor for NSC to select a subset of a plurality of available L1 NSC measurement opportunities and perform the L1 measurements of the NSC within the subset.

In the event T_SSB,SC is greater than T_SSB,NSC, the ratio may be the T_SSB,NSC to the T_SMTC. In this embodiment, the intra-layer scaling factor for NSC may be defined as (1−(T_SSB,NSC/T_SMTC))/(1−(T_SSB,NSC/T_SSB,SC)). The UE may then use the intra-layer sharing factor for NSC to select a subset of a plurality of available L1 NSC measurement opportunities and perform the L1 measurements of the NSC within the subset. The intra-layer sharing factor for SC may be set equal to one. The UE may then use the intra-layer sharing factor for SC to select a subset of a plurality of available L1 SC measurement opportunities and perform the L1 measurements of the SC within the subset.

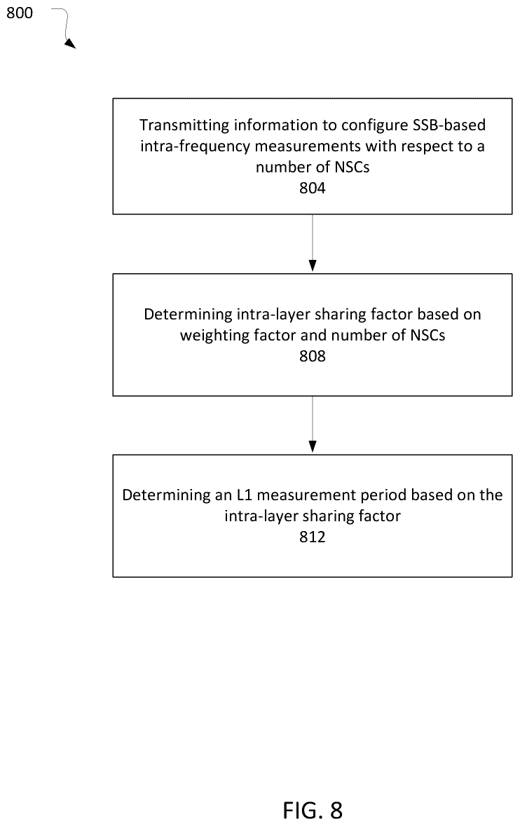

FIG. 8 illustrates an operation flow/algorithmic structure 800 in accordance with some aspects. The operation flow/algorithmic structure 800 may be performed or implemented by a serving base station, such as base station 108 or network node 1000, or components thereof; for example, baseband processor circuitry 1004A.

The operation flow/algorithmic structure 800 may include, at 804, transmitting information to configure SSB-base intra-frequency measurements with respect to a number of NSCs. The transmitted configuration information may be similar to the received configuration information described elsewhere herein including, for example, the operation flow/algorithmic structure 600 of FIG. 6.

The operation flow/algorithmic structure 800 may further include, at 808, determining an intra-layer sharing factor based on the weighting factor and the number of NSCs. The base station may determine the intra-layer sharing factor in a manner similar to that described elsewhere herein including, for example, the operation flow/algorithmic structure 600 of FIG. 6.

The operation flow/algorithmic structure 800 may further include, at 812, determining an L1 measurement period based on the intra-layer sharing factor. The base station may determine the L1 measurement period in a manner similar to that described elsewhere herein including, for example,

The base station may determine the L1 measurement period based on a DRX configuration provided to the UE. If no DRX configuration was provided, the L1 measurement period may be equal to max(T_report, ceil(M*P*N*P_L1)*T_SSB). T_report may be a configured periodicity for reporting, T_SSB may be the periodicity of an SSB index configured for L1-RSRP measurements of the SC or the NSC, T_DRX is a DRX cycle length, M is equal to one if a time restriction for channel measurement parameter is configured or is equal to three otherwise, P is the inter-layer sharing factor, and N is eight.

If the DRX configuration is not more than 320 milliseconds, the L1 measurement period may be equal to max(T_report, cell (1.5*M*P *N*P_L1)*max (T_DRX, T_SSB). The parameters may be similar to the described above and, with the exception of P_L1, described in clause 9.5.4.1 of TS 38.133.

If the DRX configuration is more than 320 milliseconds, the L1 measurement period may be equal to ceil(1.5*M*P*N*P_L1)*T_DRX. The parameters may be similar to that described above and, with the exception of P_L1, described in clause 9.5.4.1 of TS 38.133.

The base station may expect reporting of L1-RSRP measurements for the L1 measurement period. In the event that no measurements are received, the base station may assume there has been a link or beam failure and may proceed to perform link/beam recovery or reconfiguration operations.

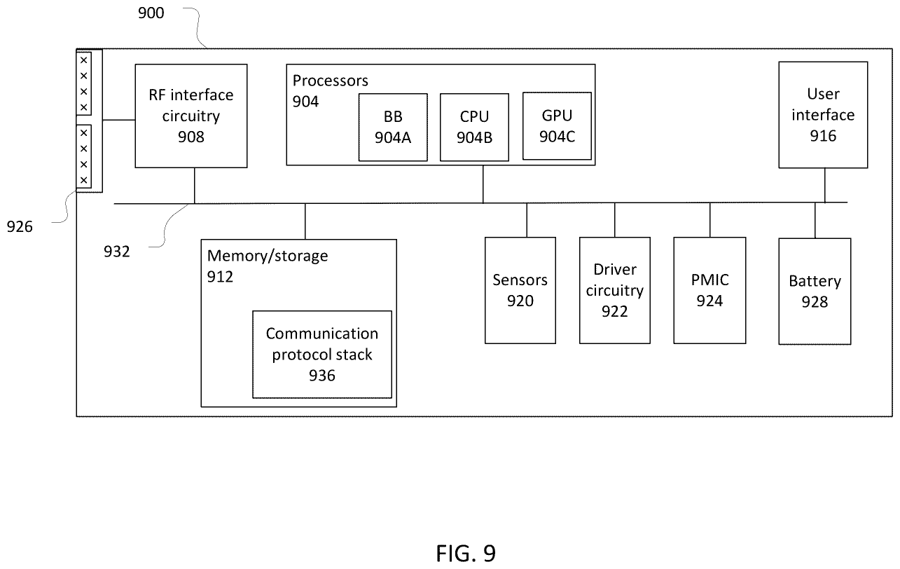

FIG. 9 illustrates a UE 900 in accordance with some embodiments. The UE 900 may be similar to and substantially interchangeable with UE 104 of FIG. 1.

The UE 900 may be any mobile or non-mobile computing device, such as, for example, mobile phones, computers, tablets, XR devices, glasses, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, or actuators), video surveillance/monitoring devices (for example, cameras or video cameras), wearable devices (for example, a smart watch), or Internet-of-things devices.

The UE 900 may include processors 904, RF interface circuitry 908, memory/storage 912, user interface 916, sensors 920, driver circuitry 922, power management integrated circuit (PMIC) 924, antenna structure 926, and battery 928. The components of the UE 900 may be implemented as integrated circuits (ICs), portions thereof, discrete electronic devices, or other modules, logic, hardware, software, firmware, or a combination thereof. The block diagram of FIG. 9 is intended to show a high-level view of some of the components of the UE 900. However, some of the components shown may be omitted, additional components may be present, and different arrangement of the components shown may occur in other implementations.

The components of the UE 900 may be coupled with various other components over one or more interconnects 932, which may represent any type of interface, input/output, bus (local, system, or expansion), transmission line, trace, or optical connection that allows various circuit components (on common or different chips or chipsets) to interact with one another.

The processors 904 may include processor circuitry such as, for example, baseband processor circuitry (BB) 904A, central processor unit circuitry (CPU) 904B, and graphics processor unit circuitry (GPU) 904C. The processors 904 may include any type of circuitry or processor circuitry that executes or otherwise operates computer-executable instructions, such as program code, software modules, or functional processes from memory/storage 912 to cause the UE 900 to perform operations as described herein.

In some embodiments, the baseband processor circuitry 904A may access a communication protocol stack 936 in the memory/storage 912 to communicate over a 3GPP compatible network. In general, the baseband processor circuitry 904A may access the communication protocol stack 936 to: perform user plane functions at a PHY layer, MAC layer, RLC sublayer, PDCP sublayer, SDAP sublayer, and upper layer; and perform control plane functions at a PHY layer, MAC layer, RLC sublayer, PDCP sublayer, RRC layer, and a NAS layer. In some embodiments, the PHY layer operations may additionally/alternatively be performed by the components of the RF interface circuitry 908.

The baseband processor circuitry 904A may generate or process baseband signals or waveforms that carry information in 3GPP-compatible networks. In some embodiments, the waveforms for NR may be based cyclic prefix OFDM (CP-OFDM) in the uplink or downlink, and discrete Fourier transform spread OFDM (DFT-S-OFDM) in the uplink.

The memory/storage 912 may include one or more non-transitory, computer-readable media that includes instructions (for example, communication protocol stack 936) that may be executed by one or more of the processors 904 to cause the UE 900 to perform various operations described herein. The memory/storage 912 include any type of volatile or non-volatile memory that may be distributed throughout the UE 900. In some embodiments, some of the memory/storage 912 may be located on the processors 904 themselves (for example, L1 and L2 cache), while other memory/storage 912 is external to the processors 904 but accessible thereto via a memory interface. The memory/storage 912 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 908 may include transceiver circuitry and radio frequency front module (RFEM) that allows the UE 900 to communicate with other devices over a radio access network. The RF interface circuitry 908 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna structure 926 and proceed to filter and amplify (with a low-noise amplifier) the signal. The signal may be provided to a receiver of the transceiver that down-converts the RF signal into a baseband signal that is provided to the baseband processor of the processors 904.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna structure 926.

In various embodiments, the RF interface circuitry 908 may be configured to transmit/receive signals in a manner compatible with NR access technologies.

The antenna structure 926 may include antenna elements to convert electrical signals into radio waves to travel through the air and to convert received radio waves into electrical signals. The antenna elements may be arranged into one or more antenna panels. The antenna structure 926 may have antenna panels that are omnidirectional, directional, or a combination thereof to enable beamforming and multiple input, multiple output communications. The antenna structure 926 may include microstrip antennas, printed antennas fabricated on the surface of one or more printed circuit boards, patch antennas, or phased array antennas. The antenna structure 926 may have one or more panels designed for specific frequency bands including bands in FR1 or FR2.

The user interface 916 includes various input/output (I/O) devices designed to enable user interaction with the UE 900. The user interface 916 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 900.

The sensors 920 may include devices, modules, or subsystems whose purpose is to detect events or changes in its environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 922 may include software and hardware elements that operate to control particular devices that are embedded in the UE 900, attached to the UE 900, or otherwise communicatively coupled with the UE 900. The driver circuitry 922 may include individual drivers allowing other components to interact with or control various I/O devices that may be present within, or connected to, the UE 900. For example, the driver circuitry 922 may include circuitry to facilitate coupling of a UICC (for example, UICC 148) to the UE 900. For additional examples, driver circuitry 922 may include a display driver to control and allow access to a display device, a touchscreen driver to control and allow access to a touchscreen interface, sensor drivers to obtain sensor readings of sensors 920 and control and allow access to sensors 920, drivers to obtain actuator positions of electro-mechanic components or control and allow access to the electro-mechanic components, a camera driver to control and allow access to an embedded image capture device, audio drivers to control and allow access to one or more audio devices.

The PMIC 924 may manage power provided to various components of the UE 900. In particular, with respect to the processors 904, the PMIC 924 may control power-source selection, voltage scaling, battery charging, or DC-to-DC conversion.

In some embodiments, the PMIC 924 may control, or otherwise be part of, various power saving mechanisms of the UE 900 including DRX as discussed herein.

A battery 928 may power the UE 900, although in some examples the UE 900 may be mounted deployed in a fixed location, and may have a power supply coupled to an electrical grid. The battery 928 may be a lithium-ion battery, a metal-air battery, such as a zinc-air battery, an aluminum-air battery, a lithium-air battery, and the like. In some implementations, such as in vehicle-based applications, the battery 928 may be a typical lead-acid automotive battery.

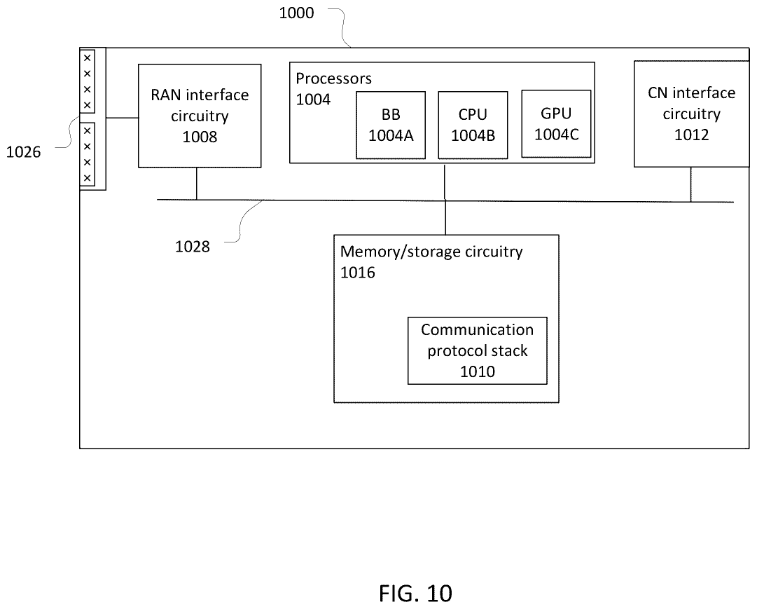

FIG. 10 illustrates a network node 1000 in accordance with some embodiments. The network node 1000 may be similar to and substantially interchangeable with base station 108.

The network node 1000 may include processors 1004, RF interface circuitry 1008 (if implemented as an access node), core network (CN) interface circuitry 1012, memory/storage circuitry 1016, and antenna structure 1026.

The components of the network node 1000 may be coupled with various other components over one or more interconnects 1028.

The processors 1004, RF interface circuitry 1008, memory/storage circuitry 1016 (including communication protocol stack 1010), antenna structure 1026, and interconnects 1028 may be similar to like-named elements shown and described with respect to FIG. 9.

The CN interface circuitry 1012 may provide connectivity to a core network, for example, a 5th Generation Core network (5GC) using a 5GC-compatible network interface protocol such as carrier Ethernet protocols, or some other suitable protocol. Network connectivity may be provided to/from the network node 1000 via a fiber optic or wireless backhaul. The CN interface circuitry 1012 may include one or more dedicated processors or FPGAs to communicate using one or more of the aforementioned protocols. In some implementations, the CN interface circuitry 1012 may include multiple controllers to provide connectivity to other networks using the same or different protocols.

In some embodiments, the network node 1000 may be coupled with transmit receive points (TRPs) using the antenna structure 1026, CN interface circuitry, or other interface circuitry.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more aspects, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary aspects are provided.

Example 1 includes a method comprising: receiving, from a serving cell (SC), information to configure synchronization signal and physical broadcast channel block (SSB)-based intra-frequency measurements with respect to a number of non-serving cells (NSCs), wherein the number is one or more; determining a first periodicity of an SSB index configured for Layer 1 (L1) measurements of the SC is equal to a second periodicity of an SSB index configured for L1 measurements of the NSC and is less than a third periodicity of an SSB measurement timing configuration (SMTC); identifying a weighting factor; and determining an intra-layer sharing factor for sharing SSB measurement opportunities between L1 measurements of the SC and L1 measurements of the NSC based the number and the weighting factor.

Example 2 includes the method of example 1 or some other example herein, wherein the number of NSCs is greater than one.

Example 3 includes a method of example 1 or some other example herein, wherein the intra-layer sharing factor (P_L1) is equal to 1−k*N_NSC, where k is the weighting factor and N_NSC is the number of NSCs.

Example 4 includes a method of example 3 or some other example herein, further comprising: identifying a plurality of available L1 SC measurement opportunities; selecting a subset of the plurality of available L1 SC measurement opportunities based on the intra-layer sharing factor; and performing the L1 measurements of the SC within the subset.

Example 5 includes the method of example 1 or some other example herein, wherein the intra-layer sharing factor (P_L1) is equal to (1+k*N_NSC)/k, where k is the weighting factor and N_NSC is the number of NSCs.

Example 6 includes the method of example 5 or some other example herein, wherein the method further comprises: identifying a plurality of available L1 NSC measurement opportunities; selecting a subset of the plurality of available L1 NSC measurement opportunities based on the intra-layer sharing factor; and performing the L1 measurements of the NSC within the subset.

Example 7 includes the method of any one of examples 3-6 or some other example herein, further comprising: determining an L1 measurement period as equal to: max(T_report, ceil(M*P*N*P_L1)*T_SSB if the UE is operating without a discontinuous reception (DRX) configuration; max(T_report, ceil(1.5*M*P*N*P_L1)*max(T_DRX, T_SSB) if the UE is operating with a DRX configuration that has a cycle length that is no more than 320 milliseconds; and ceil(1.5*M*P*N*P_L1)*T_DRX if the UE is operating with a DRX configuration that has a cycle length that is more than 320 milliseconds, where T_report is a configured periodicity for reporting, T_SSB is the first or second periodicity, T_ DRX is a DRX cycle length, M is equal to 1 if a time restriction for channel measurement parameter is configured or is equal to 3 otherwise, P is an inter-layer sharing factor, and N is equal to 8; and performing the L1 measurements of the SC or L1 measurements of the NSC within the L1 measurement period.

Example 8 includes the method of example 1 or some other example herein, wherein the weighting factor is less than one to prioritize L1 measurements of the SC over L1 measurements of the NSC, the weighting factor is greater than one to prioritize L1 measurements of the NSC over L1 measurements of the SC, or the weighting factor is equal to one to provide an equal priority between the L1 measurements of the SC and the L1 measurements of the NSC.

Example 9 includes a method comprising: receiving, from a serving cell (SC), information to configure synchronization signal and physical broadcast channel block (SSB)-based intra-frequency measurements with respect to a non-serving cell (NSC); determining a first periodicity of an SSB index configured for Layer 1 (L1) measurements of the SC is not equal to a second periodicity of an SSB index configured for L1 measurements of the NSC and both the first and second periodicities are less than a third periodicity of an SSB measurement timing configuration (SMTC); determining a ratio of the first periodicity or the second periodicity to the third periodicity; and determining an intra-layer sharing factor for sharing SSB measurement opportunities between L1 measurements of the SC and L1 measurements of the NSC based on the ratio.

Example 10 includes the method of example 9 or some other example herein, wherein the information is to configure SSB-based intra-frequency measurements with respect to one NSC.

Example 11 includes the method of example 10 or some other example herein, wherein the first periodicity is less than the second periodicity and the intra-layer sharing factor (P_L1) is equal to (1−(T_SSB,SC/T_SMTC))/(1−(T_SSB,SC/T_SSB,NSC), where T_SSB,SC is the first periodicity, T_SSB,NSC is the second periodicity, and T_SMTC is the third periodicity.

Example 12 includes the method of example 11 or some other example herein, further comprising: identifying a plurality of available L1 SC measurement opportunities; selecting a subset of the plurality of available L1 SC measurement opportunities based on the intra-layer sharing factor; and performing the L1 measurements of the SC within the subset.

Example 13 includes the method of example 12 or some other example herein, wherein the intra-layer sharing factor is a first intra-layer sharing factor for SC and the method further comprises: identifying a plurality of available L1 NSC measurement opportunities; selecting a subset of the plurality of available L1 NSC measurement opportunities based on a second intra-layer sharing factor for NSC; and performing the L1 measurements of the NSC within the subset the plurality of available L1 NSC measurement opportunities, wherein the second intra-layer sharing factor for NSC is equal to one.

Example 14 includes the method of example 10 or some other example herein, wherein the first periodicity is greater than the second periodicity and the intra-layer sharing factor (P_L1) is equal to (1−(T_SSB,NSC/T_SMTC))/(1−(T_SSB,NSC/T_SSB,SC), where T_SSB,SC is the first periodicity, T_SSB,NSC is the second periodicity, and T_SMTC is the third periodicity.

Example 15 includes the method of example 14 or some other example herein, further comprising: identifying a plurality of available L1 NSC measurement opportunities; selecting a subset of the plurality of available L1 NSC measurement opportunities based on the intra-layer sharing factor; and performing the L1 measurements of the NSC within the subset.

Example 16 includes the method of example 15 or some other example herein, wherein the intra-layer sharing factor is a first intra-layer sharing factor for NSC and the method further comprises: identifying a plurality of available L1 SC measurement opportunities; selecting a subset of the plurality of available L1 SC measurement opportunities based on a second intra-layer sharing factor for SC; and performing the L1 measurements of the SC within the subset the plurality of available L1 NSC measurement opportunities, wherein the second intra-layer sharing factor for SC is equal to one.

Example 17 includes the method of any one of examples 11-15 or some other example herein, further comprising: determining a layer 1 measurement period as: max(T_report, ceil(M *P*N*P_L1)*T_SSB if the UE is operating without discontinuous reception (DRX); max(T_report, ceil(1.5*M*P*N*P_L1)*max(T_DRX, T_SSB) if the UE is operating with DRX that is no more than 320 milliseconds; and ceil(1.5*M*P*N*P_L1)*T_DRX if the UE is operating with DRX that is more than 320 milliseconds, where T_report is a configured periodicity for reporting, T_SSB is the first or second periodicity, T_DRX is a DRX cycle length, M is equal to 1 if a time restriction for channel measurement parameter is configured or is equal to 3 otherwise, P is an inter-layer sharing factor, and N is equal to 8; and performing the L1 measurements of the SC or L1 measurements of the NSC within the L1 measurement period.

Example 18 includes a method of operating a base station, the method comprising: transmitting, to a user equipment (UE) in a serving cell (SC) provided by the base station, information to configure synchronization signal and physical broadcast channel block (SSB)-based intra-frequency measurements with respect to a number of non-serving cell (NSCs); determining an intra-layer sharing factor based on: a weighting factor and the number of NSCs; or a ratio of a first SSB periodicity to a periodicity of an SSB measurement timing configuration (SMTC), wherein the first SSB periodicity is a periodicity of an SSB index configured for Layer 1 (L1) measurements of the SC or a periodicity of an SSB index configured for L1 measurements of the NSC; and determining a L1 measurement period based on the inter-layer sharing factor.

Example 19 includes the method of example 18 or some other example herein, further comprising: determining a report corresponding to the L1 measurement period is not received; and initiating a beam or link recovery or reconfiguration operation based on said determining the report is not received.

Example 20 includes a method of example 18 or 19 or some other example herein, further comprising: determining the L1 measurement period as: max(T_report, ceil(M*P*N*P_L1)*T_SSB if the UE is operating without discontinuous reception (DRX); max(T_report, ceil(1.5*M*P*N*P_L1)*max(T_DRX, T_SSB) if the UE is operating with DRX that is no more than 320 milliseconds; and ceil(1.5*M*P*N*P_L1)*T_DRX if the UE is operating with DRX that is more than 320 milliseconds, where P_L1 is the intra-layer sharing factor, T_report is a configured periodicity for reporting, T_SSB is the first SSB periodicity, T_DRX is a DRX cycle length, M is equal to 1 if a time restriction for channel measurement parameter is configured or is equal to 3 otherwise, P is an inter-layer sharing factor, and N is equal to 8. Example 21 may include an apparatus comprising means to perform one or more elements of a method described in or related to any of examples 1-20, or any other method or process described herein.

Example 22 may include one or more non-transitory computer-readable media comprising instructions to cause an electronic device, upon execution of the instructions by one or more processors of the electronic device, to perform one or more elements of a method described in or related to any of examples 1-20, or any other method or process described herein.

Example 23 may include an apparatus comprising logic, modules, or circuitry to perform one or more elements of a method described in or related to any of examples 1-20, or any other method or process described herein.

Example 24 may include a method, technique, or process as described in or related to any of examples 1-20, or portions or parts thereof.

Example 25 may include an apparatus comprising: one or more processors and one or more computer-readable media comprising instructions that, when executed by the one or more processors, cause the one or more processors to perform the method, techniques, or process as described in or related to any of examples 1-20, or portions thereof.

Example 26 may include a signal as described in or related to any of examples 1-20, or portions or parts thereof.

Example 27 may include a datagram, information element, packet, frame, segment, PDU, or message as described in or related to any of examples 1-20, or portions or parts thereof, or otherwise described in the present disclosure.

Example 28 may include a signal encoded with data as described in or related to any of examples 1-20, or portions or parts thereof, or otherwise described in the present disclosure.

Example 29 may include a signal encoded with a datagram, IE, packet, frame, segment, PDU, or message as described in or related to any of examples 1-20, or portions or parts thereof, or otherwise described in the present disclosure.

Example 30 may include an electromagnetic signal carrying computer-readable instructions, wherein execution of the computer-readable instructions by one or more processors is to cause the one or more processors to perform the method, techniques, or process as described in or related to any of examples 1-20, or portions thereof.

Example 31 may include a computer program comprising instructions, wherein execution of the program by a processing element is to cause the processing element to carry out the method, techniques, or process as described in or related to any of examples 1-20, or portions thereof.

Example 32 may include a signal in a wireless network as shown and described herein.

Example 33 may include a method of communicating in a wireless network as shown and described herein.

Example 34 may include a system for providing wireless communication as shown and described herein.

Example 35 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of aspects to the precise form disclosed. Modifications and variations are possible in light of the above teachings or may be acquired from practice of various aspects.

Although the aspects above have been described in considerable detail, numerous variations and modifications will become apparent to those skilled in the art once the above disclosure is fully appreciated. It is intended that the following claims be interpreted to embrace all such variations and modifications.

What is claimed is:

1. One or more non-transitory, computer-readable media having instructions that, when executed by one or more processors, cause a user equipment (UE) to:
receive, from a serving cell (SC), information to configure synchronization signal and physical broadcast channel block (SSB)-based intra-frequency measurements with respect to a number of non-serving cells (NSCs), wherein the number is one or more;
determine a first periodicity of an SSB index configured for Layer 1 (L1) measurements of the SC is equal to a second periodicity of an SSB index configured for L1 measurements of an NSC and is less than a third periodicity of an SSB measurement timing configuration (SMTC);
identify a weighting factor; and
determine an intra-layer sharing factor for sharing SSB measurement opportunities between L1 measurements of the SC and L1 measurements of the NSC based the number and the weighting factor.

2. The one or more non-transitory, computer-readable media of claim 1, wherein the number of NSCs is greater than one.

3. The one or more non-transitory, computer-readable media of claim 1, wherein the intra-layer sharing factor is equal to 1+k*N_NSC, where k is the weighting factor and N_NSC is the number of NSCs.

4. The one or more non-transitory, computer-readable media of claim 3, wherein the instructions, when executed, further cause the UE to:
identify a plurality of available L1 SC measurement opportunities;
select a subset of the plurality of available L1 SC measurement opportunities based on the intra-layer sharing factor; and
perform the L1 measurements of the SC within the subset.

5. The one or more non-transitory, computer-readable media of claim 1, wherein the intra-layer sharing factor is equal to (1+k*N_NSC)/k, where k is the weighting factor and N_NSC is the number of NSCs.

6. The one or more non-transitory, computer-readable media of claim 5, wherein the instructions, when executed, further cause the UE to:
identify a plurality of available L1 NSC measurement opportunities;
select a subset of the plurality of available L1 NSC measurement opportunities based on the intra-layer sharing factor; and
perform the L1 measurements of the NSC within the subset.

7. The one or more non-transitory, computer-readable media of claim 3, wherein the instructions, when executed, further cause the UE to:
determine an L1 measurement period as equal to:
max(T_report, ceil(M*P*N*P_L1)*T_SSB if the UE is operating without a discontinuous reception (DRX) configuration;
max(T_report, ceil(1.5*M*P*N*P_L1)*max(T_DRX, T_SSB) if the UE is operating with a DRX configuration that has a cycle length that is no more than 320 milliseconds; and
ceil(1.5*M*P*N*P_L1)*T_DRX if the UE is operating with a DRX configuration that has a cycle length that is more than 320 milliseconds, where P_L1 is the intra-layer sharing factor, T_report is a configured periodicity for reporting, T_SSB is the first or second periodicity, T_DRX is a DRX cycle length, M is equal to 1 if a time restriction for channel measurement parameter is configured or is equal to 3 otherwise, P is an inter-layer sharing factor, and N is equal to 8; and
perform the L1 measurements of the SC or L1 measurements of the NSC within the L1 measurement period.

8. The one or more non-transitory, computer-readable media of claim 1, wherein the weighting factor is less than one to prioritize L1 measurements of the SC over L1 measurements of the NSC, the weighting factor is greater than one to prioritize L1 measurements of the NSC over L1 measurements of the SC, or the weighting factor is equal to one to provide an equal priority between the L1 measurements of the SC and the L1 measurements of the NSC.

9. A user equipment (UE) comprising:
radio-frequency (RF) interface circuitry; and
processing circuitry coupled with the RF interface circuitry, the processing circuitry to:
receive, from a serving cell (SC) via the RF interface circuitry, information to configure synchronization signal and physical broadcast channel block (SSB)-based intra-frequency measurements with respect to a non-serving cell (NSC);
determine a first periodicity of an SSB index configured for Layer 1 (L1) measurements of the SC is not equal to a second periodicity of an SSB index configured for L1 measurements of the NSC and both the first and second periodicities are less than a third periodicity of an SSB measurement timing configuration (SMTC);
determine a ratio of the first periodicity or the second periodicity to the third periodicity; and
determine an intra-layer sharing factor for sharing SSB measurement opportunities between L1 measurements of the SC and L1 measurements of the NSC based on the ratio.

10. The UE of claim 9, wherein the information is to configure SSB-based intra-frequency measurements with respect to one NSC.

11. The UE of claim 10, wherein the first periodicity is less than the second periodicity and the intra-layer sharing factor is equal to (1−(T_SSB,SC/T_SMTC))/(1−(T_SSB,SC/T_SSB,NSC), where T_SSB,SC is the first periodicity, T_SSB,NSC is the second periodicity, and T_SMTC is the third periodicity.

12. The UE of claim 11, wherein the processing circuitry is further to:
identify a plurality of available L1 SC measurement opportunities;
select a subset of the plurality of available L1 SC measurement opportunities based on the intra-layer sharing factor; and
perform the L1 measurements of the SC within the subset.

13. The UE of claim 12, wherein the intra-layer sharing factor is a first intra-layer sharing factor for SC and the processing circuitry is further to:
identify a plurality of available L1 NSC measurement opportunities;
select a subset of the plurality of available L1 NSC measurement opportunities based on a second intra-layer sharing factor for NSC; and
perform the L1 measurements of the NSC within the subset the plurality of available L1 NSC measurement opportunities,
wherein the second intra-layer sharing factor for NSC is equal to one.

14. The UE of claim 10, wherein the first periodicity is greater than the second periodicity and the intra-layer sharing factor is equal to (1−(T_SSB,NSC/T_SMTC))/(1−(T_SSB,NSC/T_SSB,SC), where T_SSB,SC is the first periodicity, T_SSB,NSC is the second periodicity, and T_SMTC is the third periodicity.

15. The UE of claim 14, wherein the processing circuitry is further to:
identify a plurality of available L1 NSC measurement opportunities;
select a subset of the plurality of available L1 NSC measurement opportunities based on the intra-layer sharing factor; and
perform the L1 measurements of the NSC within the subset.

16. The UE of claim 15, wherein the intra-layer sharing factor is a first intra-layer sharing factor for NSC and the processing circuitry is further to:
identify a plurality of available L1 SC measurement opportunities;
select a subset of the plurality of available L1 SC measurement opportunities based on a second intra-layer sharing factor for SC; and
perform the L1 measurements of the SC within the subset the plurality of available L1 NSC measurement opportunities,
wherein the second intra-layer sharing factor for SC is equal to one.

17. The UE of claim 11, wherein the processing circuitry is further to:
determine a layer 1 (L1) measurement period as:
max(T_report, ceil(M*P*N*P_L1)*T_SSB if the UE is operating without discontinuous reception (DRX);
max(T_report, ceil(1.5*M*P*N*P_L1)*max(T_DRX, T_SSB) if the UE is operating with DRX that is no more than 320 milliseconds; and
ceil(1.5*M*P*N*P_L1)*T_DRX if the UE is operating with DRX that is more than 320 milliseconds,
where P_L1 is the intra-layer sharing factor, T_report is a configured periodicity for reporting, T_SSB is the first or second periodicity, T_DRX is a DRX cycle length, M is equal to 1 if a time restriction for channel measurement parameter is configured or is equal to 3 otherwise, P is an inter-layer sharing factor, and Nis equal to 8; and
perform the L1 measurements of the SC or L1 measurements of the NSC within the L1 measurement period.

18. A method of operating a base station, the method comprising:
transmitting, to a user equipment (UE) in a serving cell (SC) provided by the base station, information to configure synchronization signal and physical broadcast channel block (SSB)-based intra-frequency measurements with respect to a number of non-serving cell (NSCs);
determining an intra-layer sharing factor based on: a weighting factor and the number of NSCs; or a ratio of a first SSB periodicity to a periodicity of an SSB measurement timing configuration (SMTC), wherein the first SSB periodicity is a periodicity of an SSB index configured for Layer 1 (L1) measurements of the SC or a periodicity of an SSB index configured for L1 measurements of an NSC; and
determining a L1 measurement period based on the intra-layer sharing factor.

19. The method of claim 18, further comprising:
determining a report corresponding to the L1 measurement period is not received; and
initiating a beam or link recovery or reconfiguration operation based on said determining the report is not received.

20. The method of claim 18, further comprising:
determining the L1 measurement period as:
max(T_report, ceil(M*P*N*P_L1)*T_SSB if the UE is operating without discontinuous reception (DRX);
max(T_report, ceil(1.5*M*P*N*P_L1)*max(T_DRX, T_SSB) if the UE is operating with DRX that is no more than 320 milliseconds; and
ceil(1.5*M*P*N*P_L1)*T_DRX if the UE is operating with DRX that is more than 320 milliseconds,
where P_L1 is the intra-layer sharing factor, T_report is a configured periodicity for reporting, T_SSB is the first SSB periodicity, T_DRX is a DRX cycle length, M is equal to 1 if a time restriction for channel measurement parameter is configured or is equal to 3 otherwise, P is an inter-layer sharing factor, and N is equal to 8.
